(19) United States
(12) Patent Application Publication
(10) Pub. No.: US 2013/0338291 A1
(43) Pub. Date: Dec. 19, 2013

(54) REACTIVE POLYURETHANE COMPOSITION COMPRISING ABRASION-RESISTANT FILLERS

(71) Applicants: Klaus Becker-Weimann, Karlsruhe (DE); Michael Fahrländer, Stutensee (DE)

(72) Inventors: Klaus Becker-Weimann, Karlsruhe (DE); Michael Fahrländer, Stutensee (DE)

(73) Assignee: KLEBCHEMIE M. G. BECKER GMBH & CO. KG, Weingarten/Baden (DE)

(21) Appl. No.: 13/995,633

(22) PCT Filed: Dec. 19, 2011
(86) PCT No.: PCT/EP2011/073237

§ 371 Date: Aug. 12, 2013

(30) Foreign Application Priority Data
Dec. 20, 2010 (DE) 102010063552.9

(51) Int. Cl. C08K 3/22

(52) U.S. Cl. CPC C08K 3/22
USPC 524/430

(57) ABSTRACT

The present invention relates to methods for producing a reactive polyurethane composition, by preparing in a first method step a monomer-free thermoplastic polyurethane having isocyanate-reactive groups from an isocyanate-reactive polymer or from a mixture of isocyanate-reactive polymers having a fraction of at least 90 wt % of linear molecules, by reaction with a polyisocyanate having a molecular weight <500 g/mol, in a molar deficit of the isocyanate groups of the polyisocyanate relative to the isocyanate-reactive end groups of the polymer or of the mixture of polymers, and in a second method step reacting said thermoplastic polyurethane with a low-monomer-content, isocyanate-terminal prepolymer having a residual monomer content of not greater than 0.5 wt %, in a molar ratio of the isocyanate-reactive end groups of the thermoplastic polyurethane to the isocyanate groups of the prepolymer of 1:1.1 to 1:5, to give the polyurethane composition containing reactive isocyanate groups, where the method takes place with addition of an inorganic filler component and optionally of auxiliaries and the filler component comprises particles of at least one filler which have a Mohs hardness of at least 6. The present invention further relates to reactive polyurethane compositions obtainable from such methods, to the use thereof as coating material, and to articles featuring such compositions as their surface.

The present invention relates to methods for producing a reactive polyurethane composition. The present invention further relates to reactive polyurethane compositions obtainable from such methods, to use thereof as coating material and to articles with such compositions as their surface.

A great diversity of applications require coating systems which are required to exhibit enhanced abrasion resistance. Frequently this is achieved by adding abrasion resistance enhancer fillers to the coating systems customarily used.

Furthermore, such coating systems are also to be scratch-resistant.

DE-A 195 29 987 describes, for example, methods for producing highly abrasion-resistant coating films on solid carrier materials, by scattering a wear inhibitor onto a surface possibly already carrying a coating film, and then applying a coating film to the aforementioned surface and then curing said latter coating film.

Polyurethane coating materials as scuff prevention coatings for aircraft construction are described in DE 10 2005 048 434.

DE-A 27 14 593 describes methods for coating surfaces for protection against abrasion and corrosion, by multiple application of a curing synthetic-resin coat into which abrasive particles are introduced prior to curing in each case.

With the coating materials employed to date, the problem arises that on account of the low viscosity both the particle size and the concentration of the abrasion resistance enhancer fillers are greatly limited. A further disadvantage is that such high abrasion resistances can frequently be achieved only by means of high coating application rates which, in turn, necessitate multiple application and hence a plurality of worksteps. Given the fact that owing to the abrasion resistance enhancer fillers introduced, the individual coating films cannot be sanded in the usual way, there are frequent instances of film separation.

A further problem arises from the need to hold the particles of the filler in suspension in the coating system by continual active stirring, or to apply the particles directly to the surface of the article.

There is therefore a need for improved coating systems featuring enhanced abrasion resistance and scratch resistance that at least in part do not have, or have to a reduced extent, the disadvantages identified above. Such coating systems, moreover, are also to be unobjectionable from the occupational hygiene standpoint—that is, they are required to contain or release as far as possible no hazardous substances.

One object of the present invention, therefore, is to provide such coating systems and also methods for producing them.

The object is achieved by means of a method for producing a reactive polyurethane composition, comprising the steps of
in a first method step, preparing a monomer-free thermoplastic polyurethane having isocyanate-reactive groups from an isocyanate-reactive polymer or from a mixture of isocyanate-reactive polymers having a fraction of at least 90 wt % of linear molecules by reaction with a polyisocyanate having a molecular weight of <500 g/mol with a molar deficit of the isocyanate groups of the polyisocyanate relative to the isocyanate-reactive end groups of the polymer or of the mixture of polymers, and
in a second method step, reacting said thermoplastic polyurethane with a low-monomer-content isocyanate-terminal prepolymer having a residual monomer content of not greater than 0.5 wt %, in a molar ratio of the isocyanate-reactive end groups of the thermoplastic polyurethane to the isocyanate groups of the prepolymer of 1:1.1 to 1:5 to give the polyurethane composition comprising reactive isocyanate groups,
   where the method takes place with addition of an inorganic filler component and optionally of auxiliaries and the filler component comprises particles of at least one filler which have a Mohs hardness of at least 6.

The object is further achieved by means of reactive polyurethane compositions obtainable according to the method of the invention.

A further aspect of the present invention is the use of a reactive polyurethane composition of the invention as a coating material.

A further aspect of the present invention is an article having a surface which carries at least partly a coat which features a reactive polyurethane composition of the invention.

It has been found, indeed, that the reactive polyurethane composition of the invention is especially suitable for serving as an abrasion-resistant coating. In this context it is also possible more particularly for high fractions of abrasion resistance enhancer fillers to be employed. Furthermore, even low film thicknesses are sufficient, and can be applied, moreover, in just one application step.

It has also emerged, surprisingly, that the present polyurethane composition of the invention also exhibits very good scratch resistance.

The method of the invention for producing the reactive polyurethane composition corresponds basically to the method known from WO-A 2006/056472. In contrast to the WO-A, however, the method operates with addition of an inorganic filler component, this filler component comprising particles of at least one filler that has a Mohs hardness of at least 6. This increases the abrasion resistance.

First of all, therefore, in a first method step, an isocyanate-reactive polymer or a mixture of isocyanate-reactive polymers is used, having a fraction of at least 90 wt %, preferably of at least 95 wt %, more preferably of at least 99 wt % of linear molecules. The end groups of the polymer or of the mixture-forming polymers here may preferably be hydroxyl groups, amino groups, carboxyl groups, carboxylic anhydride groups and/or mercapto groups.

Preferred isocyanate-reactive polymers are predominantly linear but also branched polyesters, more particularly difunctional but also trifunctional polyethylene glycols and polypropylene glycols, polytetrahydrofurans and also polyamides, and also mixtures thereof. It is also possible here to use the corresponding copolymers, more particularly block copolymers.

Particularly preferred polyester polyols are those which may be liquid, glassily amorphous or crystalline, and which have a number-average molecular weight of between 400 and 25 000 g/mol, more particularly between 1000 and 10 000 g/mol, very preferably between 2000 and 6000 g/mol. Particularly suitable polyester polyols of these kinds are available as commercial products, for example, under the Dynacoll® designation from Degussa AG. Further suitable polyester polyols are polycaprolactone polyesters, polycarbonate polyesters and polyester polyols based on fatty acids.

Further preferred isocyanate-reactive polymers are predominantly linear or slightly branched polyalkylene oxides, more particularly polyethylene oxides, polypropylene oxides or polytetrahydrofurans (polyoxytetramethylene oxides), having a number-average molecular weight of between 250 and 12 000 g/mol, preferably having a number-average molecular weight of between 500 and 4000 g/mol.

In the first method stage, the polyisocyanate is used in a molar deficit of its isocyanate groups relative to the isocyanate-reactive end groups of the polymer. A ratio of the isocyanate-reactive end groups of the polymer or of the mixture of polymers to the isocyanate groups of the polyisocyanate in the range from 1.1:1 to 5:1 is preferred. With particular preference the stated molar ratio is well above 1, more particularly in the range between 1.3:1 and 3:1.

The isocyanate-reactive polymer, which may also be a mixture, is reacted in the first method stage with a polyisocyanate having a molecular weight <500.

The polyisocyanate is preferably a substance or a mixture of substances selected from aromatic, aliphatic or cycloaliphatic polyisocyanates having an isocyanate functionality of between 1 and 4, preferably between 1.8 and 2.2, more preferably with the isocyanate functionality 2.

With particular preference the polyisocyanate having a molecular mass <500 is a substance or a mixture of substances from the following recitation: diisocyanatodiphenylmethanes (MDIs), more particularly 4,4′-diisocyanato-diphenylmethane and 2,4′-diisocyanatodiphenylmethane and also mixtures of different diisocyanatodiphenylmethanes; hydrogenated 4,4′-MDI (bis 4-isocyanatocyclohexyl) methane and hydrogenated 2,4′-MDI tetramethylxylylene diisocyanate (TMXDI); xylylene diisocyanate (XDI); 1,5-diisocyanatonaphthalene (NDI); diisocyanatotoluenes (TDIs), more particularly 2,4-diisocyanatotoluene, and also TDI-urethdiones, more particularly dimeric 1-methyl-2,4-phenylene diisocyanate (TDI-U), and TDI ureas; 1-isocyanato-3 -isocyanatomethyl-3,5,5 -trimethylcyclohexane (IPDI) and its isomers and derivatives, more particularly dimers, trimers and polymers and also IPDI-isocyanurate (IPDI-T); 3,3′-dimethylbiphenyl-4,4′-diisocyanate (TODI); 3,3′-diisocyanato-4,4′-dimethyl-N,N′-diphenylurea (TDIH); hexamethylene 1,6-diisocyanate (HDI) and methylenebis(4-isocyanatocyclohexane) (H₁₂MDI).

An intermediate obtained in the first method stage is a monomer-free, thermoplastic polyurethane having isocyanate-reactive groups, and this intermediate may also be termed a prepolymer having free isocyanate-reactive groups.

The thermoplastic polyurethane obtained in the first method step is reacted in a second method stage with an isocyanate-terminal prepolymer in excess, i.e. in a molar ratio of the reactive end groups of the thermoplastic polyurethane to the isocyanate groups of the prepolymer of 1:1.1 to 10—preferably 1:1.5 to 1:6—to give the end product of the isocyanate-reactive polyurethane composition.

The isocyanate excess must advantageously be selected such that the resulting reactive polyurethane composition contains an isocyanate content of at least 0.5%, but preferably at least 1 wt %, based on the overall composition.

The invention is not restricted with regard to the isocyanate-terminated prepolymers. Preference, however, is given to using isocyanate-terminated prepolymers having a low residual monomer content, especially when prepolymers based on aliphatic isocyanates are used. It is provided that they are of low monomer content, i.e. their residual monomer content is not greater than 0.5 wt %, preferably less than 0.3 wt %, more preferably less than 0.1 wt %. Suitable in particular are reaction products of polyether polyols, preferably of polypropylene glycols, and polyester polyols with polyisocyanates, more particularly diisocyanatodiphenylmethanes, diisocyanatotoluenes, diisocyanatohexane, isocyanato-3-isocyanatomethyl-3,5,5-trimethylcyclohexane (IPDI) hexamethylene 1,6-diisocyanate (HDI) and/or H₁₂MDI, and also the derivatives of these isocyanates. Particularly preferred here are prepolymers based on aliphatic isocyanates such as HDI and IPDI.

Isocyanate-terminated prepolymers of this kind, of low monomer content, are prepared by reaction of polyether polyols with an excess of polyisocyanates. After the reaction, the monomeric isocyanate still present is removed by means of thin-film evaporator.

The reaction in method stages 1 and/or 2 is carried out preferably at a temperature in the range from 80 to 140° C., more particularly from 100 to 120° C.

In one advantageous procedure for preparing the thermoplastic polyurethane in the first method stage, the isocyanate-reactive polymer or the mixture of isocyanate-reactive polymers is freed from water at 120° C. under reduced pressure. This is followed by reaction with the polyisocyanate at 80 to 140° C., preferably at 100 to 120° C.

The thermoplastic polyurethane thus produced can be isolated in this form and reacted later in the second method step with a further polyisocyanate component, more particularly a demonomerized prepolymer.

It is preferred, however, for the second method step to be carried out directly following the first method step, in the same reactor. For this purpose, the low-monomer-content prepolymer is added to the thermoplastic polyurethane prepared in the first method step, and reaction is carried out at 80 to 140° C., preferably at 100 to 120° C. The reactive polyurethane composition produced in this way is subsequently dispensed, preferably into water vapor-impermeable containers.

The invention also provides a reactive polyurethane composition obtainable by the method described above.

The reactive polyurethane composition may comprise in particular, in addition to the aforementioned inorganic filler component, other auxiliaries as well, more particularly fillers, non-reactive polymers, tackifying resins, waxes, plasticizers, additives, light stabilizers, flow control agents, accelerators, adhesion promoters, pigments, catalysts, stabilizers and/or solvents.

The non-reactive polymers may preferably be polyolefins, polyacrylates, and polymers based on ethylene and vinyl acetate having vinyl acetate contents of 0 to 80 wt % or polyacrylates and also mixtures thereof

The non-reactive components are preferably added at the beginning of the preparation of the reactive polyurethane composition but may also be added at the second method stage.

The reactive polyurethane compositions of the invention are especially suitable for use as a one-component reactive adhesive or as a coating material.

The method takes place with addition of an inorganic filler component is reacted and optionally of auxiliaries as mentioned above, with the filler component comprising particles of at least one filler which have a Mohs hardness of at least 6, preferably at least 7.

Accordingly, the filler component and optionally the auxiliaries may independently of one another be added before the first method step, during the first method step at the start, during or at the end of the production process. The filler component and optionally the auxiliaries as well may be added independently of one another between the first and second method steps. Lastly, the filler component and optionally the auxiliaries may be added independently of one another during the second method step at the start, during or at the end of the reaction, or after the second method step.

The addition of the inorganic filler component takes place preferably during the second method step, more particularly at the end of the reaction, or after the second method step.

The particles of the at least one filler preferably have an average particle diameter in the nanoparticle range (<1 μm) or in the range from 3.5 μm to 56 μm.

It is further preferred for the inorganic filler component to feature only one filler.

The at least one filler may be, for example, a metal oxide, silicon dioxide, metal carbide, silicon carbide, metal nitride, silicon nitride or boron nitride. Suitable materials are corundum, emery, a spinel and/or zirconium oxide.

The inorganic filler component preferably has a fraction in the range from 5 wt % to 60 wt %, based on the total weight of the reactive polyurethane composition. With further preference the fraction is in the range from 10 wt % to 50 wt %, even more preferably in the range from 15 wt % to 30 wt %.

The reactive polyurethane composition thus produced preferably has a viscosity of 2000 mPas to 100 000 mPas at 120° C., more preferably of 5000 to 50 000 mPas, at 120° C.

With the polyurethane composition produced in this way there is no sedimentation of the inorganic particles, since the polyurethane composition of the invention is solid at room temperature and at a typical processing temperature of 100-140° C. is still of sufficiently high viscosity to maintain the inorganic particles in suspension.

The polyurethane composition thus produced has a low fraction of residual monomeric isocyanate of preferably <0.1%, and so is also advantageous from the standpoint of occupational hygiene.

Substrates coated with the reactive polyurethane composition exhibit very high abrasion resistance and high scratch resistance.

As was stated above, a further aspect of the present invention is an article having a surface which at least partly has a coat which features a reactive polyurethane composition of the invention. This coat is preferably produced in one application.

The present invention will be illustrated by means of the working examples which follow, the invention not being confined to these examples.

### EXAMPLE 1

### (Not Inventive, One-Step Method):

A 2 l glass vessel with stirrer from Ika is charged with 350 g of Dynacoll 7390 (linear polyester from Evonik, OHN about 30 mg KOH/g), 150 g of Dynacoll 7150 (linear polyester from Evonik, OHN about 42 mg KOH/g) together with 4 g of Tinuvin B75 (light stabilizer from Ciba) and 5 g of Byk 361 (flow control agent from Byk) and this initial charge is dewatered at 130° C. for about 1 hour. Then 291 g of Desmodur XP2617 (aliphatic prepolymer of low monomer content from Bayer Material Science based on HDI, NCO content about 12.5%; residual monomer content <0.5%) are added to the mixture which is stirred under reduced pressure at 130° C. for about 2 hours until the theoretical NCO content is reached.

At the end, 300 g of Edelkorund F220 (corundum from Hermes, average particle diameter about 53 my, Mohs hardness 9) are added and the mixture is stirred under reduced pressure for 15 minutes more. The polyurethane composition produced in this way has a viscosity of 4800 mPas at 140° C. Sedimentation of the filler cannot be observed during storage at 120° C. for 6 hours.

After curing, the composition has a Shore hardness D of about 40. The reactive polyurethane coating according to example 1 was applied to a commercial laminate rod by means of an applicator roll. The film thickness here was about 70 my. After 7 days of curing at room temperature, a value of about 2600 was attained in the Taber test in accordance with DIN IS013329, and thus the coating has good abrasion resistance. Even after complete curing, the coating is not scratch-resistant (coin test).

### EXAMPLE 2

### (Not Inventive, No Filler Component):

A 2 l glass vessel with stirrer from Ika is charged with 350 g of Dynacoll 7390 (linear polyester from Evonik, OHN about 30 mg KOH/g), 150 g of Dynacoll 7150 (linear polyester from Evonik, OHN about 42 mg KOH/g) together with 4 g of Tinuvin B75 (light stabilizer from Ciba) and 5 g of Byk 361 (from Byk) and this initial charge is dewatered at 130° C. for about 1 hour. This is followed by the addition in a 1st step of 19 g of Vestanat IPDI (from Evonik; molecular weight 222 g/mol; isocyanate functionality 2) followed by stirring under reduced pressure at 130° C. for 1 hour. The molar ratio of the isocyanate-reactive end groups to the isocyanate groups of the polyisocyanate in this 1st step is 1.82. This thermoplastic polyurethane obtained in the first step has no measurable residual monomer content.

Subsequently, in a 2nd step, 181 g of Desmodur XP2617 are added to the mixture, which is stirred under reduced pressure at 130° C. for about 2 hours until the theoretical

NCO content is reached. The ratio of the isocyanate groups of the low-monomer-content prepolymer to the isocyanate-reactive thermoplastic polyurethane of the 1st stage is 4:1.

The polyurethane composition produced in this way has a viscosity of 5200 mPas at 140° C. and a residual monomer content of <0.5%. After curing, the composition has a Shore hardness D of about 55.

After 7 days of curing a value of 400-600 was attained in the Taber test in accordance with EN438, meaning that the coating does not have sufficient abrasion resistance. The coating is significantly more scratch-resistant (coin test) than the coating from example 1.

### EXAMPLE 3

### (Inventive)

A 2 l glass vessel with stirrer from Ika is charged with 350 g of Dynacoll 7390 (linear polyester from Evonik, OHN about 30 mg KOH/g), 150 g of Dynacoll 7150 (linear polyester from Evonik, OHN about 42 mg KOH/g) together with 4 g of Tinuvin B75 (light stabilizer from Ciba) and 5 g of Byk 361 (from Byk) and this initial charge is dewatered at 130° C. for about 1 hour. This is followed by the addition of 19 g of Vestanat IPDI followed by stirring under reduced pressure at 130° C. for 1 hour.

The molar ratio of the isocyanate-reactive end groups to the isocyanate groups of the polyisocyanate in this 1st step is 1.82. This thermoplastic polyurethane obtained in the first step has no measurable residual monomer content.

Subsequently, in a 2nd step, 181 g of Desmodur XP2617 are added to the mixture, which is stirred under reduced pressure at 130° C. for about 2 hours until the theoretical NCO content is reached. The ratio of the isocyanate groups of the low-monomer-content prepolymer to the isocyanate-reactive end groups of the thermoplastic polyurethane of the 1st stage is 4:1.

The polyurethane composition produced in this way has a viscosity of 5200 mPas at 140° C. and a residual monomer content of <0.5%.

At the end, 300 g of Edelkorund F220 (corundum from Hermes) is added and the mixture is stirred under reduced pressure for a further 15 minutes.

The polyurethane composition thus produced has a viscosity of about 7800 mPas at 140° C. Sedimentation of the filler cannot be observed in the course of storage for 6 hours at 120° C.

After 7 days of curing a value of 2800-3000 was attained in the Taber test in accordance with DIN ISO13329. The Shore hardness D is 60. The coating is significantly more scratch-resistant (coin test) than the coating from example 1.

The reactive polyurethane coating according to example 3, in comparison to the prior art as per examples 1 and 2, therefore unites high hardness with scratch resistance and abrasion resistance.

The melting viscosity in the above examples was determined using a calibrated HB DV2 viscometer from Brookfield with a spindle 27 and at 10 rpm. The Taber test was carried out in accordance with DIN EN13329 (Taber S42). In the coin test for scratch resistance and adhesion, a sharp-edged coin was drawn over the coated surface at an angle of approximately 45° with a highly constant pressure and the degree of scratching was evaluated. The Shore hardness was determined in accordance with DIN ISO868.

The residual monomer content is determined following derivatization of the samples by HPLC (UV detection).

1-15. (canceled)

16. A method for producing a reactive polyurethane composition, comprising the steps of
in a first method step, preparing a monomer-free thermoplastic polyurethane having isocyanate-reactive groups from an isocyanate-reactive polymer or from a mixture of isocyanate-reactive polymers having a fraction of at least 90 wt % of linear molecules by reaction with a polyisocyanate having a molecular weight of <500 g/mol with a molar deficit of the isocyanate groups of the polyisocyanate relative to the isocyanate-reactive end groups of the polymer or of the mixture of polymers, and
in a second method step, reacting said thermoplastic polyurethane with a low-monomer-content isocyanate-terminal prepolymer having a residual monomer content of not greater than 0.5 wt %, in a molar ratio of the isocyanate-reactive end groups of the thermoplastic polyurethane to the isocyanate groups of the prepolymer of 1:1.1 to 1:5 to give the polyurethane composition comprising reactive isocyanate groups,
where the method takes place with addition of an inorganic filler component and optionally of auxiliaries and the filler component comprises particles of at least one filler which have a Mohs hardness of at least 6, and where the reactive polyurethane composition has a viscosity of 2000 mPas to 100,000 mPas at 120° C.

17. The method as claimed in claim 16, characterized in that the addition of the inorganic filler component takes place during the second method step.

18. The method as claimed in claim 16, characterized in that the particles have an average particle diameter in the nanoparticle range (<1 μm) or in the range from 3.5 μm to 56 μm.

19. The method as claimed in claim 16, characterized in that the molar ratio of the isocyanate-reactive end groups of the polymer or of the mixture of polymers to the isocyanate groups of the polyisocyanate in the first method stage is in the range from 1.3:1 to 5:1.

20. The method as claimed in claim 16, characterized in that the end groups of the largely linear polymer are hydroxyl groups, amino groups, carboxyl groups, carboxylic anhydride groups and/or mercapto groups.

21. The method as claimed in claim 16, characterized in that the isocyanate-reactive polymer or the mixture of isocyanate-reactive polymers is one or more substances selected from the following recitation: polyesters, di- or trifunctional polyethylene glycols or polypropylene glycols, polytetrahydrofurans and polyamides, and also copolymers and block copolymers thereof.

22. The method as claimed in claim 16, characterized in that the polyisocyanate having a molecular weight <500 is a substance or a mixture of substances selected from aromatic, aliphatic or cycloaliphatic polyisocyanates having an isocyanate functionality between 1 and 4.

23. The method as claimed in claim 16, characterized in that the monomer-reduced isocyanate-terminated prepolymer for use in the second method stage comprises one or more substances, selected from the reaction products of polyether polyols, more particularly polypropylene glycols, and polyester polyols with polyisocyanates, more particularly diisocyanatodiphenylmethanes (MDI), diisocyanatotoluenes (TDI), diisocyanatohexane (HDI), isocyanato-3-isocyanatomethyl-3,5,5-trimethylcyclohexane (IPDI) and/or H₁₂MDI.

24. The method as claimed in claim 16, characterized in that the first and/or second method stage is carried out at a temperature in the range from 80 to 140° C., preferably from 100 to 120° C.

25. The method as claimed in claim 16, characterized in that the inorganic filler component has only one filler.

26. The method as claimed in claim 16, characterized in that the at least one filler is a metal oxide, silicon dioxide, metal carbide, silicon carbide, metal nitride, silicon nitride or boron nitride.

27. The method as claimed in claim 16, characterized in that the inorganic filler component has a fraction in the range from 5 wt % to 60 wt % based on the total weight of the reactive polyurethane composition.

28. A reactive polyurethane composition obtainable by a method as claimed in claim 16.

29. An article with a surface which at least partly has a coat which has a reactive polyurethane composition as claimed in claim 28.
